(19) United States
(12) Patent Application Publication
(10) Pub. No.: US 2011/0202164 A1
(43) Pub. Date: Aug. 18, 2011

(54) Apparatus and method for preparing product portions

(75) Inventor: Guenther Weber, Gross Nemerow (DE)

(73) Assignee: Weber Maschinenbau GmbH Breidenbach, Breidenbach (DE)

(21) Appl. No.: 12/968,899

(22) Filed: Dec. 15, 2010

(30) Foreign Application Priority Data
Dec. 22, 2009 (DE) 10 2009 060 064.7

(51) Int. Cl. G06F 19/00

(52) U.S. Cl. 700/112

(57) ABSTRACT

An apparatus for preparing portions of products, in particular food products, conveyed by means of a product conveyor, includes a plurality of robots which each define a working region. A first robot serves to sort the conveyed products in accordance with a sorting criterion. At least one second robot serves to pick up sorted products from the product conveyor and to place them down at a placement location in order to prepare a product portion satisfying a target criterion at the placement location.

The present invention relates to an apparatus for preparing portions from products conveyed by means of a product conveyor, wherein the apparatus includes a plurality of robots which each define a working region. The invention further relates to a method for preparing portions from products conveyed by means of a product conveyor.

Apparatus of the named kind are used, for example, in the food industry to pick up food products such as individual slices or pieces of meat, sausage or cheese, from a product conveyor, to transfer them and to assemble them to product portions at a placement location. The robots can be made as so-called “pick & place” robots and can be provided, for example, to transfer products from a starting conveyor of a cutting apparatus to a product placement station of a packaging machine in order there to prepare portions ready for sale.

The provision of two or more transfer robots working in parallel increases the overall speed of the transfer and enables an operation of the product conveyor at a comparatively high conveyor speed. Specific requirements with respect to the product properties and/or portion properties usually have to be observed with respect to the product portions to be prepared at the placement location. It can, for example, be desired always to collect products having approximately the same dimensions to form a portion and/or the portion should have a predetermined portion weight. With specific product kinds such as fresh meat, the individual products can, however, differ relatively considerably from one another with respect to weight or dimensions so that it is difficult for the robots to satisfy the corresponding requirements for the portions.

It is therefore an object of the invention to improve the preparation of product portions from conveyed products with as little an effort as possible.

The object is satisfied by an apparatus having the features of claim 1.

In accordance with the invention, a first robot serves to sort the conveyed products in accordance with a sorting criterion and at least one second robot serves to pick up sorted products from the product conveyor and to place them down at a placement location to prepare a product portion satisfying a target criterion at the placement location.

In other words, it is therefore the underlying general idea of the invention first to sort the conveyed products before the actual portion preparation. For this purpose, one of the robots present is used—preferably exclusively to carry out a sorting procedure. This robot will also be called a sorting robot in the following. The second robot, or every further robot, in contrast, serves in a customary manner to transfer the products and to prepare product portions and is thus also called an apportioning robot. The apportioning robot can make an optimized selection from the presorted products in order thus to satisfy the target criterion, e.g. a preset portion weight, for the portion to be prepared.

The second robot preferably follows the first robot viewed in the conveying direction or a plurality of second robots can follow the first robot one after the other viewed in the conveying direction. The first robot of a row of robots arranged in the conveying direction therefore works as a sorting robot so that every further robot (apportioning robot) can pick up already sorted products.

In accordance with an embodiment of the invention, the product conveyor includes a first conveying device and at least one second conveying device which extend parallel to one another in the conveying direction through the working regions of the robots. The conveying devices can e.g. be belt conveyors running in parallel. The first conveying device preferably leads from the associated processing machine through the working regions of all robots, whereas the second conveying device, and optionally all further conveying devices, lead from the working region of the first robot through the working region of each further robot. The robot provided for sorting can then distribute the products to the two parallel conveying devices in accordance with the sorting criterion so that the products differentiated in accordance with the desired sorting criterion are spatially separated from one another. The conveying devices moreover acts as buffers and can thus contribute to compensating a possible uneven product flow from a product processing machine, e.g. from a cutting apparatus.

The first robot preferably serves to transfer the products conveyed by the first conveying device onto the second conveying device or to leave it on the first conveying device in dependence on the sorting criterion. For example, the first robot can be operated such that underweight products remain on the first conveying device, whereas overweight products are placed onto the second conveying device and are transported parallel to the first conveying device through the working regions of all further robots.

The first robot is preferably made to sort the products so that the second conveying device conveys approximately the same number of products per time unit after the sorting as the first conveying device. This is advantageous in the sense of an efficient operation since the conveying and transfer capacities are ideally utilized.

In accordance with a further embodiment, the at least one second robot is made to pick up the sorted products from the first conveying device or from the second conveying device in dependence on the target criterion.. The transfer of the products while observing the target criterion can in this way take place particularly fast since the second robot has practically simultaneous access to products of different categories and can thus pick up a product of the desired category substantially without waiting time.

As mentioned above, the sorting criterion can include the exceeding or falling below of a predetermined product weight, e.g. of a mean product weight. Alternatively or additionally, other criteria can be taken into account such as the product size or the product shape. The sorting criterion can also be dynamic, i.e. that is vary during the operation of the apparatus. The sorting criterion can, for example, vary in dependence on the number of the products conveyed by the respective conveying devices and/or in dependence on e.g. the achieved mean weight of the product portions prepared and thus influence the number of the products to be placed onto the respective conveying devices of the product conveyor.

The target criterion can, for example, include a predetermined desired weight of the product portion to be prepared. The at least approximate observation of a predetermined desired weight of the product portions is an important aspect in the sector of the food industry since, on the one hand, the end customer is used to portions of constant weight and, on the other hand, said portions can be provided with a uniform sales price. A certain tolerance is naturally allowed in the observation of the desired weight which can be of different magnitude depending on the application.

In accordance with a further embodiment, a packaging machine is arranged in the working region of the at least one second robot (apportioning robot) and the product portions are prepared in said packaging machine. The packaging machine can include a product support on which portions are prepared at a plurality of different placement locations in accordance with a format set and which are subsequently packaged and optionally transported onward.

The invention further relates to a method for preparing portions of products conveyed by means of a product conveyor, in particular food products. In accordance with the invention, the conveyed products are sorted by means of a first robot in accordance with a sorting criterion and sorted products are picked up from the product conveyor by means of at least one second robot and are placed down at a placement location to prepare product portions satisfying the target criterion at the placement location. Such a method can be carried out with the aid of the apparatus explained above so that the advantages mentioned above apply accordingly.

Further advantageous embodiments of the invention can be seen from the dependent claims, from the description and from the drawing.

The invention will be described in the following purely by way of example with reference to a possible embodiment and to the enclosed drawing.

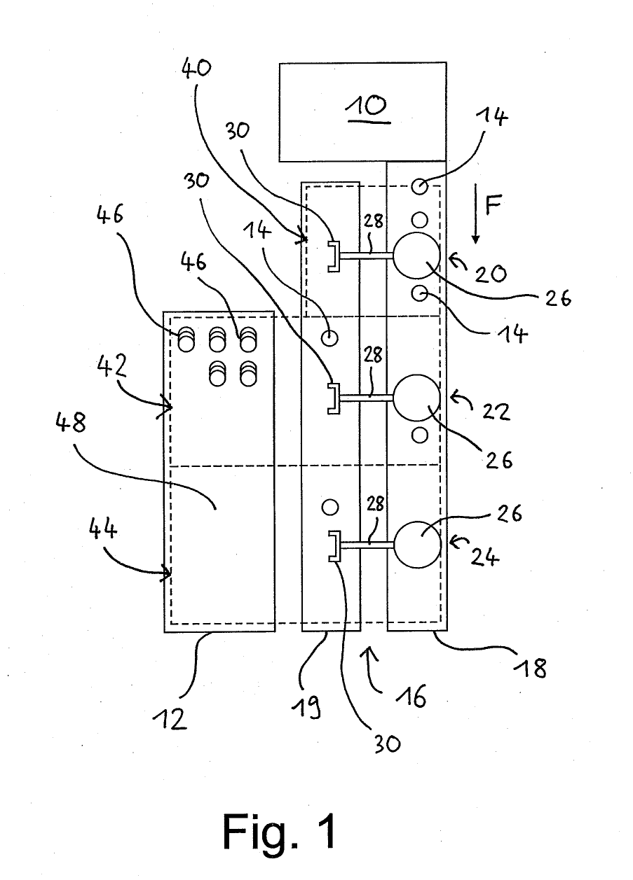

FIG. 1 shows a simplified plan view of an apparatus in accordance with the invention for preparing food product portions which includes an arrangement of three robots.

A production line is shown in FIG. 1 having a cutting apparatus 10 for slicing a food product loaf such as a loaf of sausage, meat or cheese and having a packaging machine 12 arranged after the cutting apparatus 10 for preparing portion packages ready for sale. The products cut off the product load by the cutting apparatus 10, e.g. slices or pieces, are transported by a product conveyor 16 along a conveying direction F. The product conveyor 16 includes a plurality of parallel conveying devices, in the example shown a first belt conveyor 18 and a second belt conveyor 19. The cut-off products 14 are first transported on the first belt conveyor 18 which is directly joined to the cutting apparatus 10.

An arrangement of a first robot 20, a second robot 22 and a third robot 24 is arranged in the environment of the product conveyor 16 and serves to insert the required products 14 into the packaging machine 12.

The robots 20, 22, 24 are made in the present embodiment as parallel robots with delta kinematics and each include a base 26, a movable kinematic mechanism 28 attached thereto and an end effector 30 coupled to the kinematic mechanism 28. The end effector 30 can be any desired tool by means of which the products 14 can be picked up, transported and placed down. Systems are, for example, known having two blades gripping underneath the products 14 or having a vacuum suction apparatus.

A working region 40, 42, 44 is in each case associated with the robots 20, 22, 24 and products 14 are picked up and placed down in it during normal transfer operation. The working regions 40, 42, 44 of the robots 20, 22, 24 are also called “robot cells”. Both the first belt conveyor 18 and the second belt conveyor 19 lead through all robot cells 40, 42, 44.

The first robot 20—also called a “sorting robot” in the following—serves to sort the products 14 conveyed by the product conveyor 16 in accordance with a sorting criterion. The second robot 22 and the third robot 24, which follow the first robot 20 in the conveying direction F, in contrast, serve for the preparation of product portions 46 from the individual products 14, so that the second and third robots 22, 24 are also called “apportioning robots” in the following. The number of apportioning robots 22, 24 to be provided is substantially orientated on the demanded product transfer capacity and is here only fixed at two by way of example.

The sorting robot 20 is controlled by a control device, not shown in FIG. 1, such that it transfers the products 14 conveyed by the first belt conveyor 18 to the second belt conveyor 19 or leaves them on the first belt conveyor 18 in dependence on the product weight. The weight of the individual products 14 can be detected or calculated e.g. by sensors and communicated to the control device in advance of the sorting.

In the embodiment described, products 14 which fall below a calculated or preset mean product weight are left on the first belt conveyor 18. Products 14 which exceed the preset mean product weight are, in contrast, picked up by the sorting robot 20 and placed on the second belt conveyor 19.

After the sorting procedure, products 14 of less than average weight are located on the first belt conveyor 18, whereas products 14 of above-average weight are located on the second belt conveyor 19. The result is that a flow of sorted products 14 is conveyed by the product conveyor 16 through the robot cells 42, 44 of all apportioning robots 22, 24. In this respect, an at least approximately equal distribution of the products 14 on the two parallel belt conveyors 18, 19 is targeted so that the second belt conveyor 19 therefore conveys approximately the same number of products 14 per time unit as the first belt conveyor 18 after the sorting by the sorting robot 20.

When taking a target criterion into account, each of the two apportioning robots 22, 244 picks up products 14 from the first belt conveyor 18 and/or from the second belt conveyor 19 and places them on a product support 48 of the packaging machine 12 at a preset placement location in order thus to form desired portions 46.

In the present embodiment, this target criterion is a desired weight of the portion 46 to be prepared. The apportioning robots 22, 24 are consequently operated so that the respective product 14 to be picked up next is selectively picked up from the first belt conveyor 18 or from the second belt conveyor 19 in dependence on the product weight still required for preparing a portion 46.

It can, for example, occur that a product of above-average weight 14 is still required for the completion of a portion 46. The corresponding apportioning robot 22, 24 in this case accesses the second belt conveyor 19 since it is known due to the sorting that this conveys overweight products 14. It can equally occur that a portion 46 to be completed already contains one or more overweight products 14 so that an underweight product 14 is rather to be added to achieve the desired portion weight. It can be taken from the first belt conveyor 18.

It is possible in the described manner relatively exactly to observe the desired weight of the portions 46 ready for sale. The efficiency of the total system can be increased in comparison with a portion preparation without presorting by the division of the portion preparation procedure into the individual worksteps “sorting” and “assembling”. Depending on the application requirement, the product conveyor 16 can also include three or more belt conveyors running in parallel in order thus to provide additional sorting possibilities—such as the possibility of a finer weight differentiation. Overall, an additional buffer capacity within the robot cells 42, 44 is provided by the transporting of sorted products 14 onto a plurality of belt conveyors 18, 19 running in parallel, which benefits the efficiency of the apportioning robots 22, 24.

### REFERENCE NUMERAL LIST

10 cutting apparatus

12 packaging machine

14 product

16 product conveyor

18 first belt conveyor

19 second belt conveyor

20 sorting robot

22 apportioning robot

24 apportioning robot

26 base

28 kinematic mechanism

30 end effector

40 first robot cell

42 second robot cell

44 third robot cell

46 portion

48 product support

F conveying direction

1. An apparatus for preparing portions (46) from products (14), in particular food products, conveyed by means of a product conveyor (16), comprising a plurality of robots (20, 22, 24) which each define a working region (40, 42, 44),
characterized in that
a first robot (20) serves to sort the conveyed products (14) in accordance with a sorting criterion; and
in that at least one second robot (22) serves to pick up sorted products (14) from the product conveyor (16) and to place them down at a placement location in order to prepare a product portion (46) satisfying a target criterion at the placement location.

2. An apparatus in accordance with claim 1,
characterized in that
the second robot (22) follows the first robot (20) viewed in the conveying direction (F) or a plurality of second robots (22, 24) follow the first robot (20) one after the other viewed in the conveying direction (F).

3. An apparatus in accordance with claim 1,
characterized in that
the product conveyor (16) includes a first and at least one second conveying device (18, 19) which extend parallel to one another in the conveying direction (F) through the working regions (40, 42, 44) of the robots (20, 22, 24).

4. An apparatus in accordance with claim 3,
characterized in that the first robot (20) serves to transfer the products (14) conveyed by the first conveying device (18) onto the second conveying device (19) or to leave them on the first conveying device (18) in dependence on the sorting criterion.

5. An apparatus in accordance with claim 4,
characterized in that
the first robot (20) is made to sort the products (14) such that the second conveying device (19) conveys approximately just as many products (14) per time unit as the first conveying device (18) after the sorting.

6. An apparatus in accordance with claim 3,
characterized in that
the at least one second robot (22) is made to pick up the sorted products (14) from the first conveying device (18) or from the second conveying device (19) in dependence on the target criterion.

7. An apparatus in accordance with claim 1,
characterized in that
the sorting criterion includes the falling below or exceeding of a predetermined product weight, e.g. of a mean product weight.

8. An apparatus in accordance with claim 1,
characterized in that
the target criterion includes a predetermined desired weight of the product portion (46) to be prepared.

9. An apparatus in accordance with claim 1,
characterized in that
a packaging machine (12) is arranged in the working region (42) of the at least one second robot (22) and the product portions (46) are prepared in it.

10. A method of preparing portions (46) of products (14), in particular food products, conveyed by means of a product conveyor (16),
characterized in that
the conveyed products (14) are sorted by means of a first robot (20) in accordance with a sorting criterion; and
sorted products (14) are picked up from the product conveyor (16) by means of at least one second robot (22) and are placed down at a placement location in order to prepare a product portion (46) satisfying a target criterion at the placement location.
